(19) United States
(12) Patent Application Publication
(10) Pub. No.: US 2008/0011526 A1
(43) Pub. Date: Jan. 17, 2008

(54) Hydroplaning, reducing or eliminating device

(76) Inventor: Magnar J. Grande, Metairie, LA (US)

Correspondence Address: Magnar J. Grande, Apt. 209, 3728 West Esplanade Avenue South, Metairie, LA, 70002, US

(21) Appl. No.: 11/484,798

(22) Filed: Jul. 12, 2006

(51) Int. Cl. B60K 11/00

(52) U.S. Cl. 180/53.8; 180/68.2

(57) ABSTRACT

The invention provides a method of reducing or eliminating the problem of hydroplaning when driving an automobile on a highway that has a buildup of water due to a rainfall.

Basically the device consists of an air duct outlet located in front of each wheel in such a manner that a downward high pressure air flow provided by an air compressor driven by the main engine will disperse water in front of the wheels, thereby reducing or eliminating the problem of hydroplaning.

A grilled front air intake, directed and configured to exclude an air compressor will also reduce or eliminate the problem of hydroplaning.

### BACKGROUND OF THE INVENTION

The invention relates to means and methods of reducing or eliminating the problem of hydroplaning when driving on our roads and highways. It is understood that this condition is caused by the fact that the accumulation of water under the wheels will prevent the wheels from making contact with the road surface, resulting in the loss of control of the vehicle.

### DESCRIPTION OF THE DRAWING

The above object, together with it's described features of the invention, will be apparent to one who is skilled in the art, and in light of the details of the construction of the “Hydroplaning, reducing or eliminating device” as shown in the drawing and described in the detailed disclosure.

FIG. 1 in the drawing shows a side elevation view of a most typical installation.

FIG. 2 in the drawing shows a front elevation view.

### DESCRIPTION OF THE INVENTION

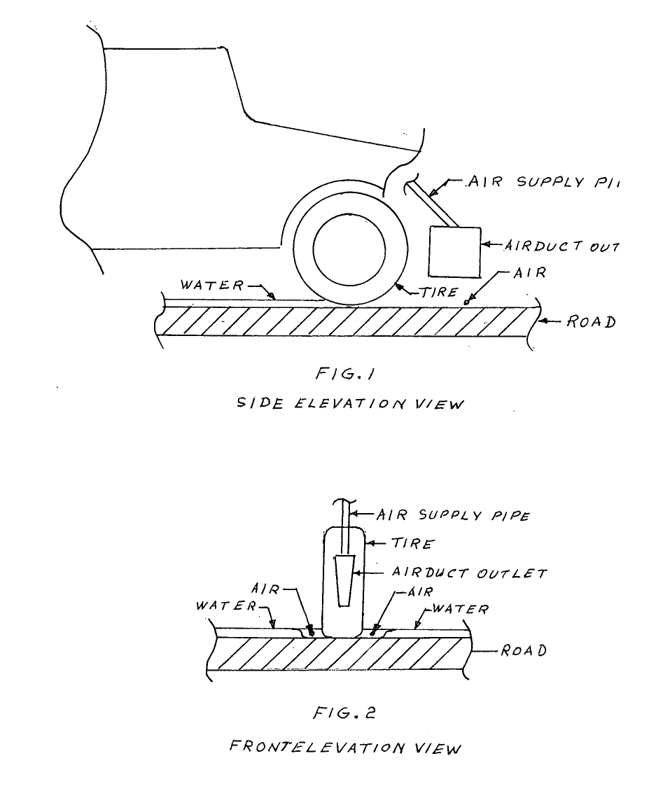

Referring to FIG. 1 and FIG. 2 in the drawing, the device can be made of aluminum or sheet steel materials.

The air duct outlet, as shown has an air supply pipe in the middle.

What I claim in my invention is:

1. Means of reducing or eliminating the problem of hydroplaning on our roads and highways by using a high compression air compressor driven by the main engine and directing the air flow in order to disperse water in front of the wheels.

2. Means of reducing or eliminating the problem of hydroplaning on our roads and highways by arranging a grilled, front air intake, directed and configured to exclude the use of an air compressor.
